(19) United States
(12) Patent Application Publication
(10) Pub. No.: US 2018/0210492 A1
(43) Pub. Date: Jul. 26, 2018

(54) VIRTUAL REALITY HEAD-MOUNTED DISPLAY

(71) Applicant: Microjet Technology Co., Ltd., Hsinchu (TW)

(72) Inventors: Shih-Chang CHEN, Hsinchu (TW); Li-Pang MO, Hsinchu (TW); Jia-Yu LIAO, Hsinchu (TW); Hsien-Ting HUANG, Hsinchu (TW); Chi-Feng HUANG, Hsinchu (TW); Yung-Lung HAN, Hsinchu (TW)

(73) Assignee: Microjet Technology Co., Ltd., Hsinchu (TW)

(21) Appl. No.: 15/878,959

(22) Filed: Jan. 24, 2018

(30) Foreign Application Priority Data
Jan. 25, 2017 (TW) 106102764

(51) Int. Cl. G06F 1/16; F04B 49/06; F04B 49/22; F04B 45/047

(52) U.S. Cl. CPC G06F 1/163; F04B 45/047; F04B 49/22; F04B 49/06

(57) ABSTRACT

A virtual reality head-mounted display is disclosed which comprises an inflatable lining module disposed within a frame of a monitor main body coupled with a positioning band. The inflatable lining module is composed of a foam body, an inflatable cushion, an air passage, an air pump, an air pressure sensor, a contact sensor and a control module. When the contact sensor detects an external pressure, it sends an enabling signal to the control module to drive the air pump to operate, and an air is introduced to the inflatable cushion through the air passage to inflate the inflatable cushion, so that the form of the foam body is correspondingly adjusted. When the air pressure sensor detects the pressure inside the inflatable cushion higher than a specified threshold interval, it sends a disabling signal to the control module, and the air pump is accordingly controlled to stop operating.

### FIELD OF THE INVENTION

The present invention relates to a virtual reality head-mounted display, and more particularly to a virtual reality head-mounted display having an inflatable lining module.

### BACKGROUND OF THE INVENTION

With the advancement of science and technology, the traditional 2D video/audio display apparatus can no longer satisfy the consumers, and the trend is towards the virtual reality display having 3D effect. Currently, the head-mounted type of virtual reality display is seen most often, which is to be fixed on the head of the user usually by one or more bands. However, such design of the virtual reality display has some drawbacks. When the user puts on the virtual reality display, the virtual reality display should be positioned on the user's face to entirely cover the eye area, such that the optical system of the virtual reality display can be right in front of the eyes of the user, and the headphones of the virtual reality display can be right over the ears of the user. For positioning the virtual reality display well, the band is designed to be tightly fitting the head of the user. Due to tightness of the band, it is inconvenient to adjust the position when the user is wearing the virtual reality display. Moreover, the user's face is tightly pressed by the virtual reality display during wearing it. That is, the virtual reality display is not only inconvenient to be adjusted according to the profile of the user's face, but also uncomfortable for the user.

Therefore, there is a need of providing a virtual reality head-mounted display to solve the drawbacks in prior arts, which can be inflated and adjusted to fit the profile of user's face, and to provide a comfort wearing experience.

### SUMMARY OF THE INVENTION

The present invention provides a virtual reality head-mounted display which can be inflated and adjusted to fit the profile of the user's face, so as to provide a comfort wearing experience.

In accordance with an aspect of the present invention, a virtual reality head-mounted display is provided and comprises a monitor main body, a positioning band and an inflatable lining module. The monitor main body comprises a frame. The positioning band is coupled with the frame. The inflatable lining module is correspondingly disposed within the frame, including a foam body, an inflatable cushion, an air passage, an air pump, a contact sensor, an air pressure sensor, and a control module. The foam body is correspondingly disposed within the frame, and the inflatable cushion is correspondingly disposed with the foam body. The air passage is communicated with the inflatable cushion, the air pump is communicated with the air passage, and the air pressure sensor is disposed in the air passage. The contact sensor is disposed on one side of the foam body. The control module is electrically connected with the air pump, the contact sensor, and the air pressure sensor. When the contact sensor detects an external pressure, the contact sensor sends an enabling signal to the control module, and the control module drives the air pump according to the enabling signal, such that an air is introduced to the inflatable cushion through the air passage. Thus, the inflatable cushion is inflated and expanded, and the form of the foam body is correspondingly adjusted in response to the external pressure and the expansion of the inflatable cushion. When the air pressure sensor detects the pressure inside the inflatable cushion higher than a specified threshold interval, the air pressure sensor sends a disabling signal to the control module, and the air pump is controlled to stop operating by the control module according to the disabling signal. Hence, the degree of expansion of the inflatable cushion is automatically adjusted to an optimum level.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic front perspective view illustrating a virtual reality head-mounted display according to an embodiment of the present invention;

FIG. 1B is a schematic rear perspective view illustrating the virtual reality head-mounted display of FIG. 1A;

FIG. 2 is a schematic exploded view illustrating an inflatable lining module of the virtual reality head-mounted display of FIG. 1A;

FIG. 3 is a schematic cross-sectional view illustrating an inflatable lining module of the virtual reality head-mounted display according to a first embodiment of the present invention;

FIG. 4 is a schematic cross-sectional view illustrating an inflatable lining module of the virtual reality head-mounted display according to a second embodiment of the present invention;

FIG. 5 is a schematic block diagram illustrating a control system of the inflatable lining module of the virtual reality head-mounted display according to the embodiment of the present invention;

FIG. 6A and FIG. 6B are schematic exploded views illustrating different perspectives of an air pump according to the embodiment of the present invention;

FIG. 7 is a schematic cross-sectional view illustrating a piezoelectric actuator of FIGS. 6A and 6B;

FIG. 8 is a schematic cross-sectional view illustrating an air pump of FIGS. 6A and 6B; and

FIG. 9A to FIG. 9E schematically illustrate the actions of the air pump of FIGS. 6A and 6B.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

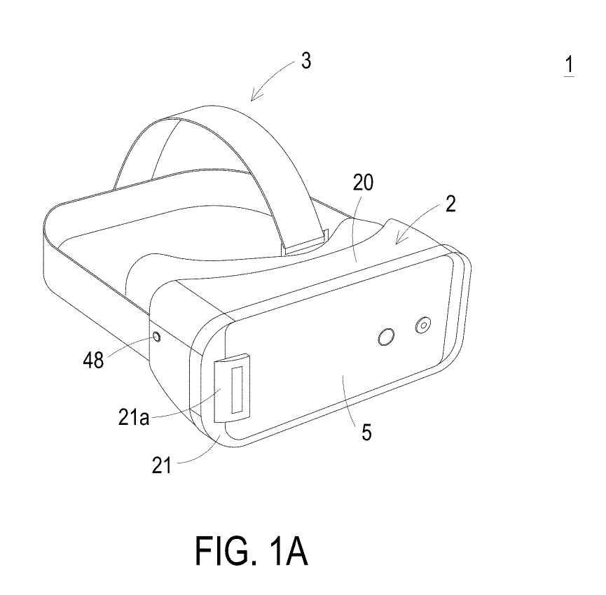

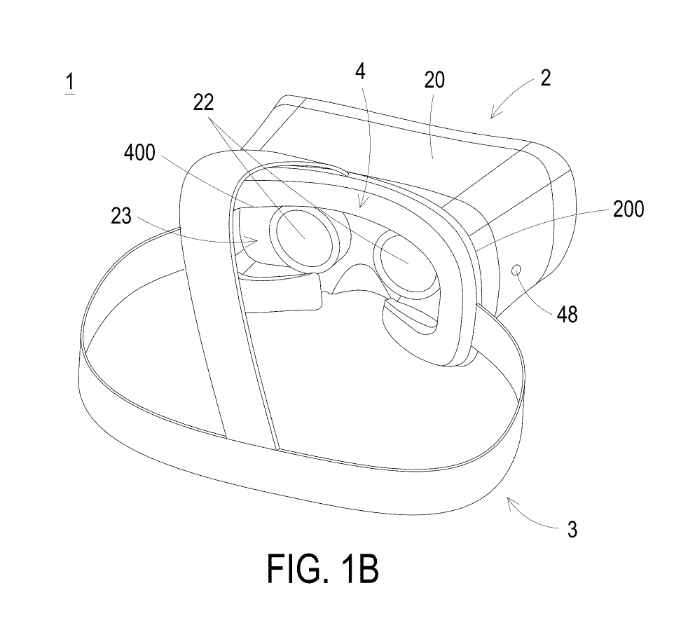

Please refer to FIG. 1A and FIG. 1B. FIG. 1A is a schematic front perspective view illustrating a virtual reality head-mounted display according to an embodiment of the present invention. FIG. 1B is a schematic rear perspective view illustrating the virtual reality head-mounted display of FIG. 1A. As shown in FIGS. 1A and 1B, the virtual reality head-mounted display 1 includes a monitor main body 2, a positioning band 3 and an inflatable lining module 4. In addition to be utilized in the virtual reality head-mounted display 1, the inflatable lining module 4 can also widely apply to various kinds of wearable device those are worn by faces. Since the inflatable lining module 4 is inflatable and adjustable, it can fit the shape of the user's face so as to provide a comfort wearing experience.

Please refer to FIG. 1A. The monitor main body 2 has a frame 20 and a base 21. In some embodiments, the outer surface of the base 21 further comprises a cramping element 21a for cramping an electronic device 5, such as a smartphone, but not limited herein. In another embodiment, the electronic device 5 can be cramped inside the base 21, the disposed manners are not limited to the above embodiments, and can be adjustable according the practical requirement. As shown in FIG. 1A, the positioning band 3 is coupled with the frame 20 of the monitor main body 2. In some embodiments, the positioning band 3 is made of elastic fabric, and the material and the type can also be adjustable according the practical requirement. In other embodiments, the virtual reality head-mounted display 1 further comprises a headphone system (not shown), which can be a separated structure with the monitor main body 2 and the positioning band 3, or can be a fixed structure sewing on the positioning band 3, but not limited herein.

Please refer to FIG. 1B. The rear structure of the virtual reality head-mounted display 1 of the present invention is illustrated. The monitor main body 2 of the virtual reality head-mounted display 1 is a box structure composed of the frame 20 and the base 21, wherein the frame 20 has an opening 200. The inflatable lining module 4 is disposed within the frame 20, while the profile of the inflatable lining module 4 substantially matches that of the frame 20, and the inflatable lining module 4 has a hollow part where an opening 400 is defined. The opening 400 communicates with an inner space 23 of the monitor main body 2. When the virtual reality head-mounted display 1 is not worn on the user's head, the inner space 23 of the monitor main body 2 can be communicated with outer space through the opening 400. Moreover, inside the monitor main body 2, there are a plurality of optical elements 22 for adjusting the optical routes to display a video/audio file of the electronic device 5 in 3D performance.

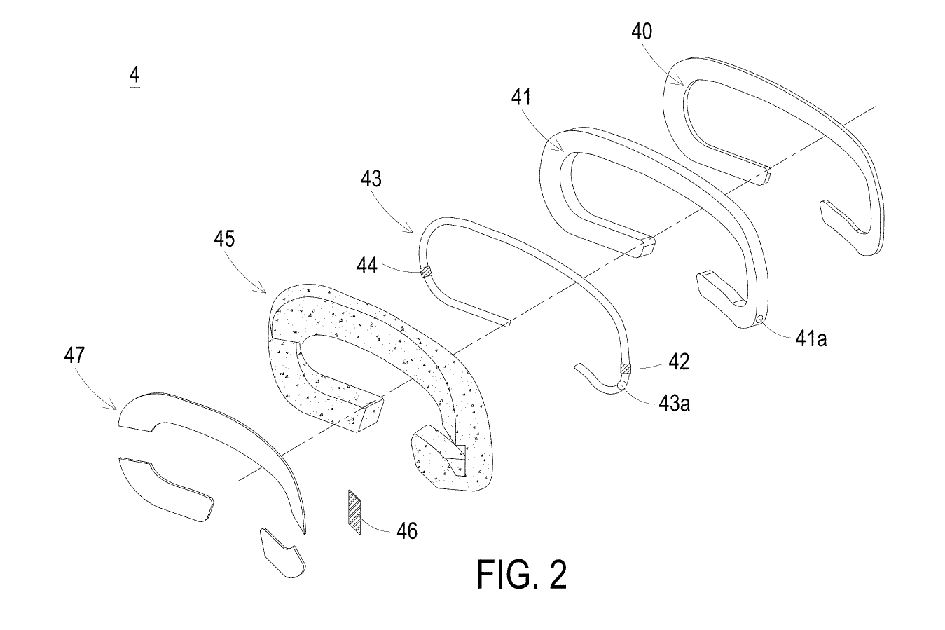

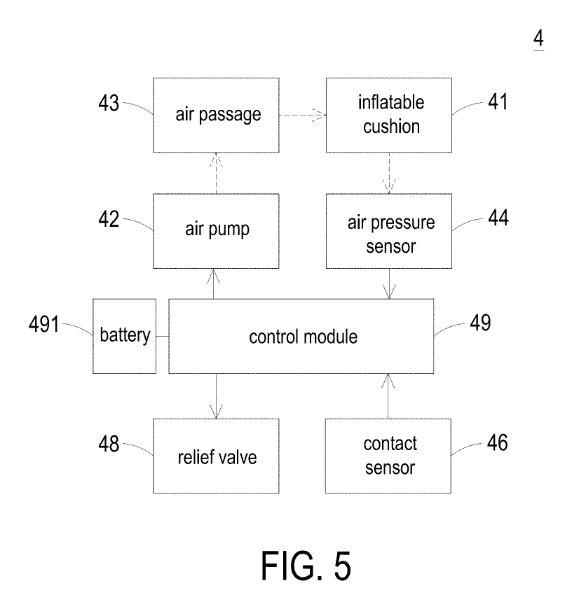

Please refer to FIG. 2, which is a schematic exploded view illustrating an inflatable lining module of the virtual reality head-mounted display of FIG. 1A. As shown in FIG. 2, the inflatable lining module 4 of the present invention comprises an inflatable cushion 41, an air pump 42, an air passage 43, an air pressure sensor 44, a foam body 45, a contact sensor 46 and a control module 49 (as shown in FIG. 5), but not limited herein. The foam body 45 is correspondingly disposed within the frame 20 of the monitor main body 2, and the inflatable cushion 41 is disposed on the foam body 45 correspondingly. The air passage 43 is communicated with the inflatable cushion 41, and the air pump 42 is also communicated with the air passage 43. The air pressure sensor 44 is disposed within the air passage 43, and the contact sensor 46 is disposed on one side of the foam body 45, but not limited herein. In this embodiment, the inflatable lining module 4 further comprises a base plate 40 and a lining 47, but not limited herein. The profiles of the base plate 40, the inflatable cushion 41, the air passage 43, the foam body 45 and the lining 47 are substantially identical and approximately match the profile of the opening 200 of the frame 20, thereby they can be correspondingly coupled with each other and correspondingly disposed in the frame 20.

In some embodiments, the inflatable lining module 4 further comprises a relief valve 48. The relief valve 48 may be disposed on a side surface of the frame 20 of the monitor main body 2 and is communicating with the air passage 43 and inflatable cushion 41 for releasing pressure of the inflatable cushion 41. The control module 49 is electrically connected with the air pump 42, the air pressure sensor 44, the contact sensor 46, the relief valve 48 and a battery 491 (as shown in FIG. 5), respectively. According to the signals which may be received from the air pressure sensor 44 or the contact sensor 46, the control module 49 controls the air pump 42 to operate or stop operating, as well as controlling the relief valve 48 to perform a pressure relief action.

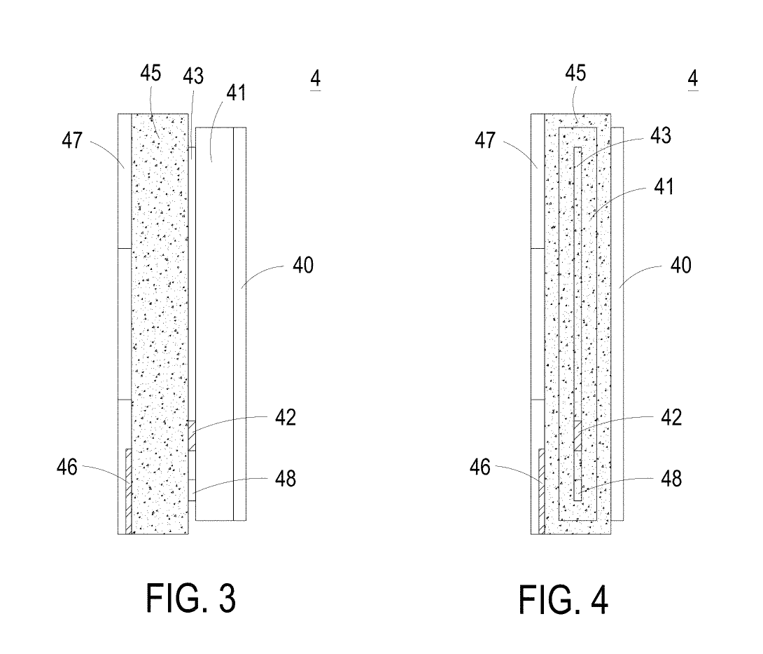

Please refer to FIG. 2 and FIG. 3, FIG. 3 is a schematic cross-sectional view illustrating an inflatable lining module of the virtual reality head-mounted display according to a first embodiment of the present invention. As shown in FIG. 2 and FIG. 3, in this embodiment, the base plate 40, the inflatable cushion 41, the air passage 43, the foam body 45 and the lining 47 are sequentially assembled as shown in FIG. 3. One side of the base plate 40 is directly attaching on the inner rim of the opening 200 of the frame 20, whereas another side is coupled with the inflatable cushion 41. The inflatable cushion 41 and the air passage 43 are disposed between the base plate 40 and the foam body 45. In some embodiments, the air passage 43 may be constructed by connecting a plurality of hollow hoses, but not limited thereto. The air passage 43 is distributed between the inflatable cushion 41 and the foam body 45 and communicating with the inflatable cushion 41 for transporting gas.

In this embodiment, the inflatable cushion 41 may be but not limited to an inflatable and expandable structure formed integrally, having a plurality of inflatable cushion holes (not shown) formed on a surface thereof. The air passage 43 also includes a plurality of air passage holes (not shown). The number, size and position of the air passage holes of the air passage 43 correspond to the inflatable cushion holes of the inflatable cushion 41, so that the air passage holes and the inflatable cushion holes are positioned to be in connection with each other, by which access between the air passage 43 and the inflatable cushion 41 for gas to pass is provided. When the air pump 42 pumps air into the air passage 43, the air passage 43 communicates air to the inflatable cushion 41, so that the inflatable cushion 41 is inflated and expanded.

In this embodiment, the foam body 45 is but not limited to a memory foam. The inflatable cushion 41 is adjacent to the foam body 45 while at least a part of it is abutting against the foam body 45. Therefore, when the inflatable cushion 41 is inflated and expanded, the form of the foam body 45 is correspondingly adjusted, thereby fitting the profile of the user's face more closely.

In this embodiment, the lining 47 is made of a light and comfort fabric, which fit closely with the user's face to provide a soft and comfort feeling. As shown in FIG. 3, the contact sensor 46 is for example but not limited to be embedded between the foam body 45 and the lining 47. The contact sensor 46 is for sensing an external pressure and accordingly sending a signal when the external pressure is detected. When the virtual reality head-mounted display 1 is worn by the user, the monitor main body 2 covers the user's eye area and the lining 47 of the inflatable lining module 4 is directly contacted with the user's face. At this moment, the contact sensor 46 detects an external pressure from the user's face and thereby sends an enabling signal to the control module 49 (shown in FIG. 5). The control module 49 accordingly enables the air pump 42 to inflate the inflatable cushion 41 through the air passage 43. The form of the foam body 45 is correspondingly adjusted in response to the external pressure from the user's face and a steady pressure provided by the inflatable cushion 41, so that the foam body 45 can closely fit the profile of the user's face and provide a soft and comfort wearing experience.

As shown in FIG. 2 and FIG. 3, the air pressure sensor 44 may be disposed in the air passage 43. The air pressure sensor 44 is for sensing the pressure inside the inflatable cushion 41. When the air pressure sensor 44 detects the pressure inside the inflatable cushion 41 higher than a specified value interval, it sends a disabling signal to the control module 49. The control module 49 accordingly disables the air pump 42, thus the inflatable cushion 41 stops being inflated. The specified threshold interval is set to ensure that the inflatable cushion 41 has the proper pressure, by which the users is provided with comfort wearing experiences.

Please refer to FIG. 2 and FIG. 4. FIG. 4 is a schematic cross-sectional view illustrating an inflatable lining module of the virtual reality head-mounted display according to a second embodiment of the present invention. In this embodiment, the structures and the operations of the base plate 40, the inflatable cushion 41, the air pump 42, the air passage 43, the air pressure sensor 44, the foam body 45, the contact sensor 46 and the lining 47 are the same as those of the previous embodiment and will not be described in details herein. In this embodiment, the inflatable cushion 41 and the air passage 43 are both wrapped by the foam body 45, and the foam body 45 is disposed between the base plate 40 and the lining 47. More specifically, the air passage 43 is distributed within the inflatable cushion 41, so that the air can be transported through the air passage 43 to the inner space of the inflatable cushion 41 directly. Once the air pump 42 is in action, the air is pumped into the inflatable cushion 41 through the air passage 43, and the inflated and expanded inflatable cushion 41 provides the foam body 45 with a steady pressure. Therefore, the form of the foam body 45 is adjustable in response to the steady pressure from the inflatable cushion 41 and the profile of the user's face, so as to fit the user's face and provide a soft, comfort, being-covered and being-buffered wearing experience.

Please refer to FIG. 5, which is a schematic block diagram illustrating a control system of the inflatable lining module of the virtual reality head-mounted display according to the embodiment of the present invention. In this embodiment, the inflatable lining module 4 of virtual reality head-mounted display 1 further has a control system, and the control system includes a control module 49, a battery 491 and a relief valve 48. The control module 49 is electrically connected with the air pump 42, the air pressure sensor 44, the contact sensor 46 and the relief valve 48, respectively. The control module 49 respectively receives the signals sent from air pressure sensor 44 and the contact sensor 46, and controls the air pump 42 to operate or to stop operating according to the received signals. When the control module 49 drives the air pump 42 to operate, the air is pumped into the air passage 43 and introduced into the inflatable cushion 41, and the pressure inside the inflatable cushion 41 is monitored by the air pressure sensor 44 which may be disposed in the air passage 43. When the air pressure sensor 44 detects the pressure inside the inflatable cushion 41 higher or lower than the specified threshold interval, the air pressure sensor 44 sends a disabling signal or an enabling signal to the control module 49 to stop the operation of the air pump 42 or to restart the air pump 42. In addition, the relief valve 48 is a pressure adjustment mechanism, which is disposed on a side surface of the frame 20 of the monitor main body 2 (as shown in FIG. 1A and FIG. 1B), and is communicated with the air passage 43 and the inflatable cushion 410. The relief valve 48 is electrically connected with the control module 49, so that when the control module 49 receives a pressure relief signal sent from the contact sensor 46, the relief valve 48 is controlled correspondingly to perform a pressure relief action. The control module 49 may be disposed on the inner side of the frame 20 where is adjacent to the relief valve 48 or adjacent to the air pump 42, but not limited thereto. The battery 491 may be a lithium battery or a mercury battery, which is for providing electric power to the control module 49. The location where the battery 491 is disposed may also on the inner side of the frame 20 adjacent to the relief valve 48, but not limited herein.

Please refer to FIG. 1A, FIG. 1B, FIG. 2 and FIG. 5 at the same time. When the user is going to wear the virtual reality head-mounted display 1, through adjusting the position of the positioning band 3, the monitor main body 2 would be fixed on the user's face and the inflatable lining module 4 would touch the user's face, in this embodiment, by the outermost lining 47 thereof. Once the inflatable lining module 4 is in contact with the user's face, the contact sensor 46 detects the external pressure and sends an enabling signal to the control module 49, and the control module 49 drives the air pump 42 to actuate according to the received enabling signal, such that the air is introduced to the inflatable cushion 41 through the air passage 43, and the inflatable cushion 41 is inflated and expanded. Being affected by expansion of the inflatable cushion 41 and the external pressure from the user's face, the form of the foam body 45 is correspondingly adjusted.

In addition, when the air pressure sensor 44 senses that the pressure inside the inflatable cushion 41 is higher than the specified threshold interval, the air pressure sensor 44 sends a disabling signal to the control module 49, and the control module 49 controls the air pump 42 to stop operating according to the disabling signal. Therefore, excessive pressure in the inflatable cushion 41 which may cause discomfort to the user's face is avoided. Oppositely, when the air pressure sensor 44 senses that the pressure inside the inflatable cushion 41 is lower than the specified threshold interval, the air pressure sensor 44 sends an enabling signal to the control module 49, and the control module 49 drives the air pump 42 to operate according to the enabling signal. Through the regulation by the air pressure sensor 44, the degree of expansion of the inflatable cushion 41 is intelligently and automatically adjusted. While the user is wearing the virtual reality head-mounted display 1, the foam body 45 is adjusted to be corresponding to expansion of the inflatable cushion 41, so that the positioning band 3 is well-fitting for the user's face. Therefore, the virtual reality head-mounted display 1 of the present invention advantageously provides a soft, fluffy, comfort, fit and being-buffered wearing experience.

In addition, the inflatable lining module 4 of this embodiment further has an air pressure adjustment function. As shown in FIG. 1A, FIG. 1B, FIG. 2 and FIG. 5, the inflatable lining module 4 includes the relief valve 48 disposed on the side surface of the frame 20 of the monitor main body 2, and the relief valve 48 may be but not limited to a switchable valve structure. As shown in FIG. 2, the air passage 43 includes a relief valve opening 43a, and the inflatable cushion 41 includes a relief valve opening 41a. The locations of the relief valve openings 43a and 41a are corresponding to the relief valve 48, and the relief valve openings 43a and 41a and the relief valve 48 are in communication with each other. As described above, the relief valve 48 is electrically connected with the control module 49 and is for discharging the air inside the inflatable cushion 41 out of the virtual reality head-mounted display 1. Once the relief valve 48 is open, the air is discharged through the relief valve opening 41a of the inflatable cushion 41 to the relief valve opening 43a of the air passage 13, and leaves out by the relief valve 48. Therefore, when the user puts off the virtual reality head-mounted display 1, the contact sensor 46 senses the external pressure has been loss or disappearance and sends a disabling signal and a pressure relief signal to the control module 49. After receiving the disabling signal and the pressure relief signal, the control module 49 controls the air pump 42 to stop operating according to the disabling signal, and meanwhile, the control module 46 drives the relief valve 48 to switch on according to the pressure relief signal, and at least part of the air inside the inflated and expanded inflatable cushion 41 is discharged out of the virtual reality head-mounted display 1 through the open relief valve 48. Consequently, the internal air pressure of the inflatable lining module 4 is adjusted automatically and intelligently according to the usage status, so that the inflatable cushion 41 is avoided being inflated for a long time which may result in reduction of the using life of itself, and the user can wear the virtual reality head-mounted display 1 in the most comfortable state.

In some embodiments, the relief valve 48 may be but not limited to a rotary button, and is manually actuated to switch on or off by screwing or unscrewing the rotary button. Therefore, the user is able to adjust the internal air pressure of the inflatable lining module 4 through the rotary button, unscrewing the rotary button to switch the relief valve 18 on so as to release the pressure of the inflatable cushion 41, and screwing the rotary button to switch the relief valve 18 off for stopping pressure releasing. As a result, the degree of expansion of the inflatable cushion 41 and the tightness of fixing state of the virtual reality head-mounted display 1 are manually adjustable to achieve an optimum status for the wearer.

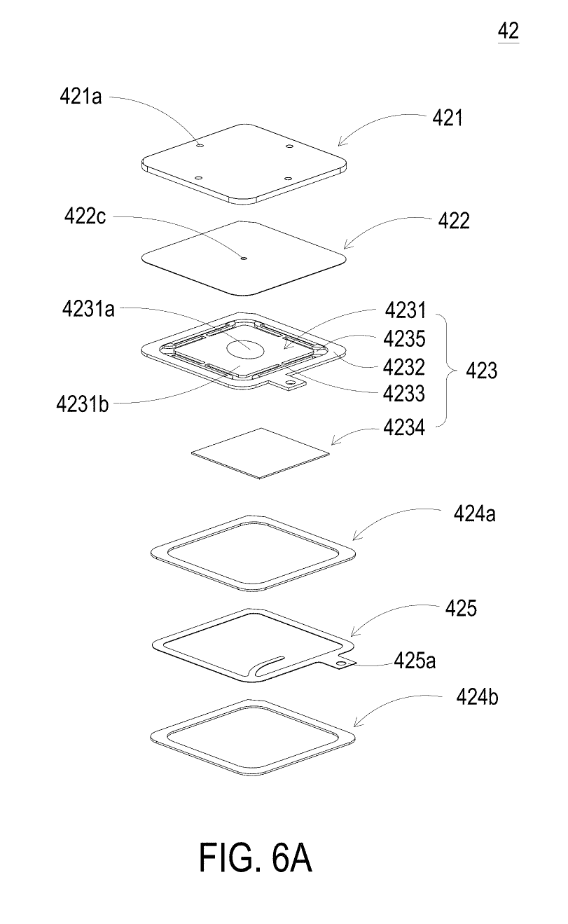

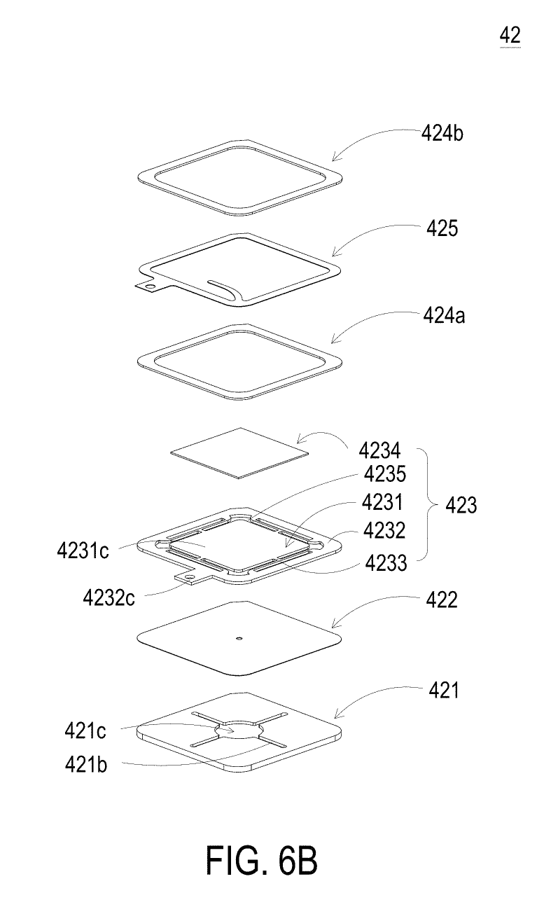

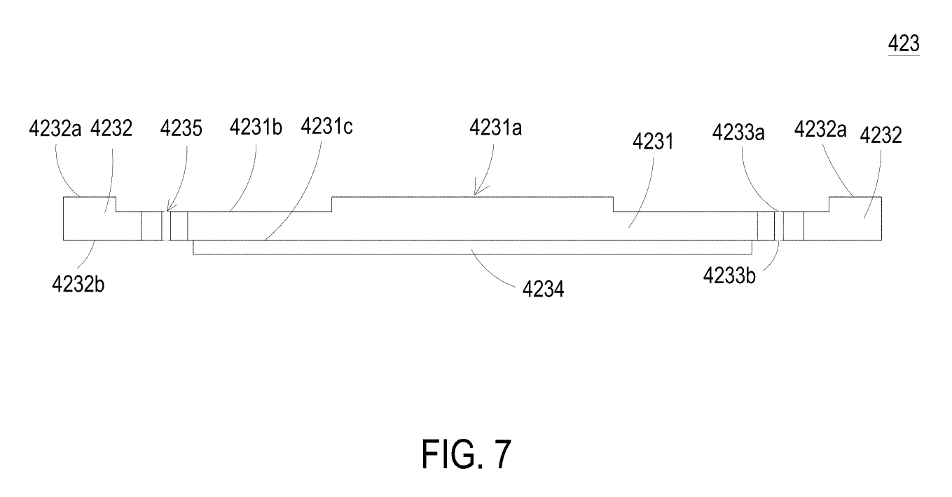

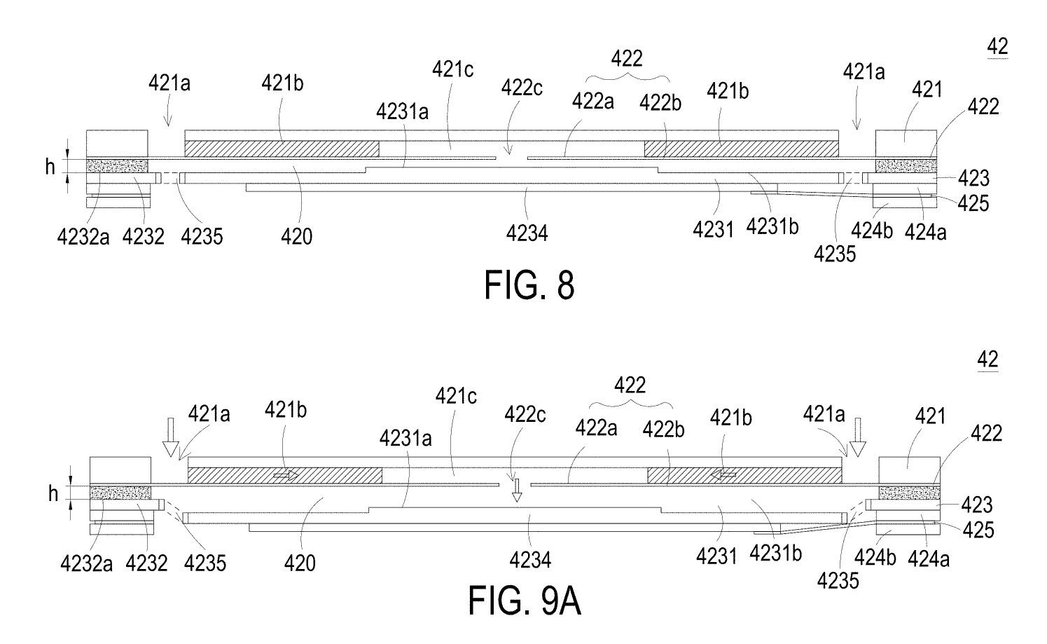

FIG. 6A and FIG. 6B are schematic exploded views illustrating different perspectives of an air pump according to the embodiment of the present invention. FIG. 7 is a schematic cross-sectional view illustrating a piezoelectric actuator of FIGS. 6A and 6B. FIG. 8 is a schematic cross-sectional view illustrating an air pump of FIGS. 6A and 6B. As shown in FIG. 6A, FIG. 6B, FIG. 7 and FIG. 8, the air pump 42 is a piezoelectric air pump. Moreover, the air pump 42 comprises a gas inlet plate 421, a resonance plate 422, a piezoelectric actuator 423, a first insulation plate 424a, a conducting plate 425 and a second insulation plate 424b. The piezoelectric actuator 423 is aligned with the resonance plate 422. The gas inlet plate 421, the resonance plate 422, the piezoelectric actuator 423, the first insulation plate 424a, the conducting plate 425 and the second insulation plate 424b are stacked on each other sequentially. After the above components are combined together, the cross-sectional view of the resulting structure of the air pump 42 is shown in FIG. 8.

The gas inlet plate 421 comprises at least one inlet 421a. Preferably but not exclusively, the gas inlet plate 421 comprises four inlets 421a. The inlets 421a run through the gas inlet plate 421. In response to the action of the atmospheric pressure, the air is introduced into the air pump 42 through the inlets 421a. Moreover, at least one convergence channel 421b is formed on a first surface of the gas inlet plate 421, and is in communication with the at least one inlet 421a in a second surface of the gas inlet plate 421. Moreover, a central cavity 421c is located at the intersection of the four convergence channels 421b. The central cavity 421c is in communication with the at least one convergence channel 421b, such that the gas entered by the inlets 421a would be introduced into the at least one convergence channel 421b and is guided to the central cavity 421c. Consequently, the air can be transferred by the air pump 42. In this embodiment, the at least one inlet 421a, the at least one convergence channel 421b and the central cavity 421c of the gas inlet plate 421 are integrally formed. The central cavity 421c is a convergence chamber for temporarily storing the air. Preferably but not exclusively, the gas inlet plate 421 is made of stainless steel. In some embodiments, the depth of the convergence chamber defined by the central cavity 421c is equal to the depth of the at least one convergence channel 421b. The resonance plate 422 is made of a flexible material, which is preferably but not exclusively copper. The resonance plate 422 further has a central aperture 422c corresponding to the central cavity 421c of the gas inlet plate 421 that providing the gas for flowing through.

The piezoelectric actuator 423 comprises a suspension plate 4231, an outer frame 4232, at least one bracket 4233 and a piezoelectric plate 4234. The piezoelectric plate 4234 is attached on a first surface 4231c of the suspension plate 4231. In response to an applied voltage, the piezoelectric plate 4234 would be subjected to a deformation. When the piezoelectric plate 4233 is subjected to the deformation, the suspension plate 4231 is subjected to a curvy vibration. The at least one bracket 4233 is connected between the suspension plate 4231 and the outer frame 4232, while the two ends of the bracket 4233 are connected with the outer frame 4232 and the suspension plate 4231 respectively that the bracket 4233 can elastically support the suspension plate 4231. At least one vacant space 4235 is formed between the bracket 4233, the suspension plate 4231 and the outer frame 4232 for allowing the air to go through. The type of the suspension plate 4231 and the outer frame 4232 and the type and the number of the at least one bracket 4233 may be varied according to the practical requirements. The outer frame 4232 is arranged around the suspension plate 4231. Moreover, a conducting pin 4232c is protruding outwardly from the outer frame 4232 so as to be electrically connected with an external circuit (not shown).

As shown in FIG. 7, the suspension plate 4231 has a bulge 4231a that makes the suspension plate 4231 a stepped structure. The bulge 4231a is formed on a second surface 4231b of the suspension plate 4231. The bulge 4231b may be a circular convex structure. A top surface of the bulge 4231a of the suspension plate 4231 is coplanar with a second surface 4232a of the outer frame 4232, while the second surface 4231b of the suspension plate 4231 is coplanar with a second surface 4233a of the bracket 4233. Moreover, there is a drop of specified amount from the bulge 4231a of the suspension plate 4231 (or the second surface 4232a of the outer frame 4232) to the second surface 4231b of the suspension plate 4231 (or the second surface 4233a of the bracket 4233). A first surface 4231c of the suspension plate 4231, a first surface 4232b of the outer frame 4232 and a first surface 4233b of the bracket 4233 are coplanar with each other. The piezoelectric plate 4234 is attached on the first surface 4231c of the suspension plate 4231. The suspension plate 4231 may be a square plate structure with two flat surfaces but the type of the suspension plate 4231 may be varied according to the practical requirements. In this embodiment, the suspension plate 4231, the at least bracket 4233 and the outer frame 4232 are integrally formed and produced by using a metal plate (e.g., a stainless steel plate). In an embodiment, the length of the piezoelectric plate 4234 is smaller than the length of the suspension plate 4231. In another embodiment, the length of the piezoelectric plate 4234 is equal to the length of the suspension plate 4231. Similarly, the piezoelectric plate 4234 is a square plate structure corresponding to the suspension plate 4231.

In an embodiment, as shown in FIG. 6A, in the air pump 42, the first insulation plate 424a, the conducting plate 425 and the second insulation plate 424b are stacked on each other sequentially and located under the piezoelectric actuator 423. The profiles of the first insulation plate 424a, the conducting plate 425 and the second insulation plate 424b substantially match the profile of the outer frame 4232 of the piezoelectric actuator 423. The first insulation plate 424a and the second insulation plate 424b are made of an insulating material (e.g. a plastic material) for providing insulating efficacy. The conducting plate 425 is made of an electrically conductive material (e.g. a metallic material) for providing electrically conducting efficacy. Moreover, the conducting plate 425 has a conducting pin 425a so as to be electrically connected with an external circuit (not shown).

In an embodiment, as shown in FIG. 8, the gas inlet plate 421, the resonance plate 422, the piezoelectric actuator 423, the first insulation plate 424a, the conducting plate 425 and the second insulation plate 424b of the air pump 42 are stacked on each other sequentially. Moreover, there is a gap h between the resonance plate 422 and the outer frame 4232 of the piezoelectric actuator 423, which is formed and maintained by a filler (e.g. a conductive adhesive) inserted therein in this embodiment. The gap h ensures the proper distance between the bulge 4231a of the suspension plate 4231 and the resonance plate 422, so that the contact interference is reduced and the generated noise is largely reduced. In some embodiments, the height of the outer frame 4232 of the piezoelectric actuator 423 is increased, so that the gap is formed between the resonance plate 422 and the piezoelectric actuator 423.

After the gas inlet plate 421, the resonance plate 422 and the piezoelectric actuator 423 are combined together, a movable part 422a and a fixed part 422b of the resonance plate 422 are defined. A convergence chamber for converging the air is defined by the movable part 422a of the resonance plate 422 and the gas inlet plate 421 collaboratively. Moreover, a first chamber 420 is formed between the resonance plate 422 and the piezoelectric actuator 423 for temporarily storing the air. Through the central aperture 422c of the resonance plate 422, the first chamber 420 is in communication with the central cavity 421c of the gas inlet plate 421. The peripheral regions of the first chamber 420 are in communication with the air passage 43 through the vacant space 4235 between the brackets 4233 of the piezoelectric actuator 423.

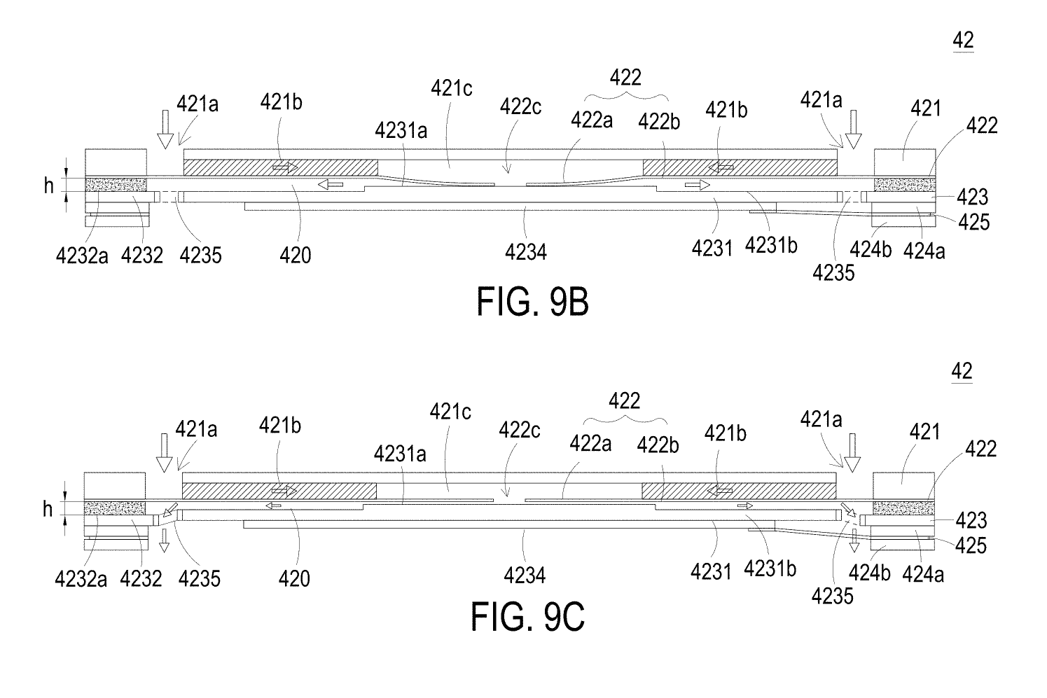

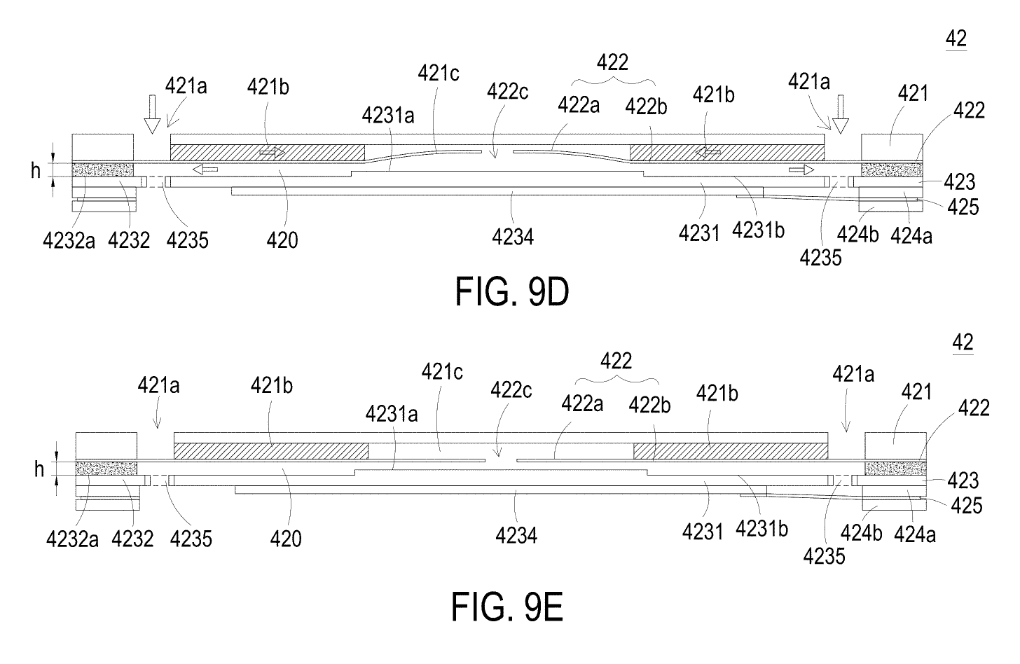

FIG. 9A to FIG. 9E schematically illustrate the actions of the air pump of FIGS. 6A and 6B. Please refer to FIG. 8 and FIG. 9A to FIG. 9E. The actions of the air pump will be described as follows. When the air pump 42 is enabled, the piezoelectric actuator 423 is vibrated along a vertical direction in a reciprocating manner by using the bracket 4233 as the fulcrums. The resonance plate 422 except for the part of it fixed on the gas inlet plate 421 is hereinafter referred as a movable part 422a, while the rest is referred as a fixed part 422b. Since the resonance plate 422 is light and thin, the movable part 422a vibrates along with the piezoelectric actuator 423 because of the resonance of the piezoelectric actuator 423. In other words, the movable part 422a is reciprocated and subjected to a curvy deformation. As shown in 9A, when the piezoelectric actuator 423 is vibrated downwardly, the movable part 422a of the resonance plate 422 is subjected to the curvy deformation because the movable part 422a of the resonance plate 422 is pushed by the air and vibrated in response to the piezoelectric actuator 423. In response to the downward vibration of the piezoelectric actuator 423, the air is introduced into the at least one inlet 421a of the gas inlet plate 421. Then, the air is transferred to the central cavity 421c of the gas inlet plate 421 through the at least one convergence channel 421b. Then, the air is transferred through the central aperture 422c of the resonance plate 422 corresponding to the central cavity 421c, and introduced downwardly into the first chamber 420. As the piezoelectric actuator 423 is enabled, the resonance of the resonance plate 422 occurs. Consequently, the resonance plate 422 is also vibrated along the vertical direction in the reciprocating manner. As shown in FIG. 9B, during the vibration of the movable part 422a of the resonance plate 422, the movable part 422a moves down till bring contacted with the bulge 4231a of the suspension plate 4231. In the meantime, the volume of the first chamber 420 is shrunken and a middle space which was communicating with the convergence chamber is closed. Under this circumstance, the pressure gradient occurs to push the air in the first chamber 420 moving toward peripheral regions of the first chamber 420 and flowing downwardly through the vacant spaces 4235 of the piezoelectric actuator 423. As shown in FIG. 9C, the movable part 422a of the resonance plate 422 has returned its original position when, the piezoelectric actuator 423 has ascended at a vibration displacement to an upward position. Consequently, the volume of the first chamber 420 is consecutively shrunken that generating the pressure gradient which makes the air in the first chamber 420 continuously pushed toward peripheral regions. Meanwhile, the air continuously introduced into the inlets 421a of the gas inlet plate 421 and transferred to the central cavity 421c. Then, as shown in FIG. 9D, the resonance plate 422 moves upwardly, which is caused by the resonance of the upward motion of the piezoelectric actuator 423. Consequently, the air is slowly introduced into the inlets 421a of the gas inlet plate 421, and transferred to the central cavity 421c. Finally, as shown in FIG. 9E, the movable part 422a of the resonance plate 422 has returned its original position. When the resonance plate 422 is vibrated along the vertical direction in the reciprocating manner, the gap h between the resonance plate 422 and the piezoelectric actuator 423 providing space for vibration of the resonance plate 422. That is, the thickness of the gap h affects the amplitude of vibration of the resonance plate 422. Consequently, a pressure gradient is generated in the fluid channels of the air pump 42 to facilitate the air to flow at a high speed. Moreover, since there is an impedance difference between the feeding direction and the exiting direction, the air can be transmitted from the inlet side to the outlet side. Moreover, even if the outlet side has a gas pressure, the air pump 42 still has the capability of pushing the air to the air passage 43 while achieving the silent efficacy. The steps of FIG. 9A to FIG. 9E are repeatedly done. Consequently, the ambient air is transferred by the air pump 42 from the outside to the inside.

As mentioned above, the operation of the air pump 42 can guide the air into the air passage 43, such that the air that is guided is introduced to the inflatable cushion 41, the inflatable cushion 41 is inflated and expanded, and meanwhile, the foam body 45 can be correspondingly adjusted to fit the profile of the user's face, therefore a unfit problem is avoided. Meanwhile, due to the expansion of the inflatable cushion 41, a soft, fluffy, comfort, fit and being-buffered wearing experience may also be achieved.

From the above descriptions, the present invention provides a virtual reality head-mounted display, which may be applied in a wearable device wearing on face. By providing the external pressure produced from the user's wearing on face to the contact sensor of the inflatable lining module, the inflatable cushion is inflated automatically and intelligently through the inflatable lining module, and the shape of the foam body is adjusted in response to the expansion level of the inflatable cushion, so as to closely fit the profile of the user's face, and to provide a soft, comfort wearing experience. Furthermore, by providing the inflatable lining module with an air pressure adjustment function, the internal pressure may be automatically adjusted according to the using state, such that the life span of the inflatable cushion is extended, and the user may wear the virtual reality head-mounted display under the most comfortable pressure. Meanwhile, the user may manually adjust the pressure inside the inflatable cushion, thereby providing more convenient operation and wider applicability.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A virtual reality head-mounted display comprising:
a monitor main body comprising a frame;
a positioning band coupled with the frame; and
an inflatable lining module correspondingly disposed within the frame, comprising:
a foam body;
an inflatable cushion correspondingly disposed with the foam body;
an air passage communicated with the inflatable cushion;
an air pump communicated with the air passage;
an air pressure sensor disposed in the air passage;
a contact sensor disposed on one side of the foam body; and
a control module electrically connected with the air pump, the contact sensor, and the air pressure sensor;
wherein when the contact sensor detects an external pressure, the contact sensor sends an enabling signal to the control module, and the control module accordingly drives the air pump to operate, so that an air is introduced to the inflatable cushion through the air passage by which the inflatable cushion is inflated and expanded, and the form of the foam body is correspondingly adjusted in response to the external pressure and the expansion of the inflatable cushion, wherein when the air pressure sensor detects the pressure inside the inflatable cushion higher than a specified threshold interval, the air pressure sensor sends a disabling signal to the control module, and the control module accordingly controls the air pump to stop operating.

2. The virtual reality head-mounted display according to claim 1, wherein the inflatable lining module further comprising a base plate, the base plate is correspondingly disposed within the frame.

3. The virtual reality head-mounted display according to claim 2, wherein the inflatable cushion and the air passage are disposed between the base plate and the foam body, and the air passage is disposed between the inflatable cushion and the foam body.

4. The virtual reality head-mounted display according to claim 2, wherein the inflatable lining module further comprising a lining, the lining is disposed on one side surface of the foam body, and the contact sensor is arranged between the foam body and the lining

5. The virtual reality head-mounted display according to claim 4, wherein the inflatable cushion and the air passage are disposed inside the foam body, and the foam body is disposed between the base plate and the lining.

6. The virtual reality head-mounted display according to claim 1 further comprising a relief valve, wherein the relief valve is disposed on a side surface of the frame of the monitor main body, and the relief valve is communicated with the air passage and the inflatable cushion.

7. The virtual reality head-mounted display according to claim 6, wherein the relief valve is manually actuated to discharge the air out of the inflatable lining module through the relief valve.

8. The virtual reality head-mounted display according to claim 6, wherein the relief valve is electrically connected with the control module, and when the contact sensor detects loss or disappearance of the external pressure, the contact sensor sends a pressure relief signal to the control module, and the control module drives the relief valve according to the pressure relief signal to discharge the air out of the inflatable lining module through the relief valve.

9. The virtual reality head-mounted display according to claim 1, wherein the control module comprises a battery to provide electric power to the control module.

10. The virtual reality head-mounted display according to claim 1, wherein the air pump is a piezoelectric air pump.

11. The virtual reality head-mounted display according to claim 10, wherein the piezoelectric air pump comprises:
a gas inlet plate comprising at least one inlet, at least one convergence channel and a central cavity, wherein a convergence chamber is defined by the central cavity, and the at least one convergence channel corresponds to the at least one inlet, wherein after the air is introduced into the at least one convergence channel through the at least one inlet, the air is guided by the at least one convergence channel and converged to the convergence chamber;
a resonance plate having a central aperture, wherein the central aperture is aligned with the convergence chamber, wherein the resonance plate comprises a movable part near the central aperture; and
a piezoelectric actuator aligned with the resonance plate, wherein a gap is formed between the resonance plate and the piezoelectric actuator to define a first chamber, wherein when the piezoelectric actuator is driven, the air is introduced into the air pump through the at least one inlet of the gas inlet plate, converged to the central cavity through the at least one convergence channel, transferred through the central aperture of the resonance plate, and introduced into the first chamber, wherein the air is further transferred through a resonance between the piezoelectric actuator and the movable part of the resonance plate.

12. The virtual reality head-mounted display according to claim 11, wherein the piezoelectric actuator comprises:
a suspension plate having a first surface and an opposing second surface, wherein the suspension plate is permitted to undergo a curvy vibration;
an outer frame arranged around the suspension plate;
at least one bracket connected between the suspension plate and the outer frame for elastically supporting the suspension plate; and
a piezoelectric plate, wherein a length of the piezoelectric plate is smaller than or equal to a length of the suspension plate, and the piezoelectric plate is attached on the first surface of the suspension plate, wherein when a voltage is applied to the piezoelectric plate, the suspension plate is driven to undergo the curvy vibration.

13. The virtual reality head-mounted display according to claim 12, wherein the suspension plate is a square suspension plate having a bulge.

14. The virtual reality head-mounted display according to claim 11, wherein the piezoelectric air pump further comprises a conducting plate, a first insulation plate and a second insulation plate, wherein the gas inlet plate, the resonance plate, the first insulation plate, the conducting plate and the second insulation plate are stacked on each other sequentially.
